(19) United States
(12) Patent Application Publication
(10) Pub. No.: US 2026/0139797 A1
(43) Pub. Date: May 21, 2026

(54) BIOGAS STORAGE APPARATUS, AND BIOGAS DISCHARGING METHOD

(71) Applicant: AIR WATER INC., Osaka (JP)

(72) Inventors: Saki FUJII, Osaka (JP); Rikako KISHI, Osaka (JP)

(21) Appl. No.: 19/122,226

(22) PCT Filed: Oct. 2, 2023
(86) PCT No.: PCT/JP2023/035904

§ 371 Date: Apr. 17, 2025

(30) Foreign Application Priority Data
Oct. 18, 2022 (JP) 2022-166672

(51) Int. Cl. F17C 7/00; F17C 13/04

(52) U.S. Cl. CPC F17C 7/00; F17C 13/04; F17C 2201/058; F17C 2221/033

(57) ABSTRACT

A biogas storage apparatus comprises: a tank including an adsorbent to adsorb a biogas for storing the biogas; a biogas inlet/outlet plumbing connected to the tank for introducing the biogas into the tank and discharging the biogas from the tank; and a biogas return plumbing that interconnects the tank and the biogas inlet/outlet plumbing for returning to the tank at least a portion of the biogas discharged from the tank.

### TECHNICAL FIELD The present disclosure relates to a biogas storage apparatus and a biogas discharging method.

### BACKGROUND ART

In recent years, biogas derived from urine and feces of livestock such as dairy cows and beef cows has attracted attention due to problems such as global warming and depletion of fossil fuel. Biogas has mainly been used in large-scale ranches or the like to generate electric power by a power generator and sell the generated electric power. However, medium-and small-scale farms and the like having no power generator have insufficiently utilized biogas. In addition, even if it is possible to generate electric power, it is difficult to sell the electric power due to insufficient power grids.

Accordingly, a method has been studied to allow farms to store collected biogas in a storage apparatus having an adsorbent introduced therein, transport the stored biogas to a collection site, and separate and purify the transported biogas. Handling a biogas in this manner is believed to have a characteristic similar to conventional natural gas separation and purification.

PTL 1 (Japanese Patent Laying-Open No. 2002-267097) discloses a storage apparatus that adsorbs natural gas by an adsorbent introduced in a pressure device, and also discloses that when the natural gas is desorbed from the adsorbent, heating facilitates the desorption.

PTL 2 (Japanese Patent Laying-Open No. 2008-240835) discloses a method for adsorbing a gas such as natural gas to a pressure-resistant container having an adsorbent introduced therein to collect and reuse the gas, and also discloses that the pressure-resistant container is mounted on a vehicle and a temperature control unit is used to control heat of adsorption and desorption.

### CITATION LIST

### Patent Literature

PTL 1: Japanese Patent Laying-Open No. 2002-267097
PTL 2: Japanese Patent Laying-Open No. 2008-240835

### SUMMARY OF INVENTION

### Technical Problem

The apparatus described in PTL 1 is configured provided that it is used in a stationary manner and stores natural gas for a long period of time. It is not assumed to be portable or to adsorb and desorb natural gas in a short period of time. In addition, a heater is provided on a side surface of the pressure device to facilitate desorption, and such a configuration is also predicated on being used in a stationary manner ensuring a heat source.

While PTL 2 indicates that the pressure-resistant container is provided with a thermal medium plumbing, a temperature control unit, etc., the document does not specifically disclose what mechanism it has.

An object of the present disclosure is to provide a biogas storage apparatus and a biogas discharging method capable of efficiently discharging a biogas.

### Solution to Problem

[1] A biogas storage apparatus comprising:
a tank including an adsorbent to adsorb a biogas for storing the biogas,
a biogas inlet/outlet plumbing connected to the tank for introducing the biogas into the tank and discharging the biogas from the tank; and
a biogas return plumbing that interconnects the tank and the biogas inlet/outlet plumbing for returning to the tank at least a portion of the biogas discharged from the tank.

[2] The biogas storage apparatus according to [1], wherein
the biogas inlet/outlet plumbing includes a first biogas inlet/outlet plumbing and a second biogas inlet/outlet plumbing,
the first biogas inlet/outlet plumbing is connected to a first side surface of the tank,
the second biogas inlet/outlet plumbing is connected to a second side surface of the tank, and
the second side surface is a side surface opposite to the first side surface.

[3] The biogas storage apparatus according to [2], wherein
the tank has a longitudinal direction and a lateral direction, and
the first side surface and the second side surface are side surfaces transverse to the longitudinal direction.

[4] The biogas storage apparatus according to [3], installed and used such that the longitudinal direction is a horizontal direction,

[5] The biogas storage apparatus according to any one of [1] to [4], further comprising a compressor that compresses at least a portion of the biogas discharged from the tank.

[6] The biogas storage apparatus according to any one of [2] to [5], comprising:
a first valve that opens and closes the biogas inlet/outlet plumbing; and
a second valve that opens and closes the biogas return plumbing, wherein
the first valve and the second valve are provided on a side closer to the first side surface,

[7] The biogas storage apparatus according to any one of [1] to [6], being portable.

[8] The biogas storage apparatus according to any one of [1] to [7], wherein
the biogas is a gas derived from at least one selected from the group consisting of livestock urine and feces and food residues, and
the biogas includes at least methane and carbonic acid gas.

[9] A method for discharging a biogas from a biogas storage apparatus according to any one of [1] to [8], comprising:
discharging the biogas from the tank; and
returning to the tank at least a portion of the biogas discharged in the discharging,
the returning being performed while the discharging is performed.

[10] The method for discharging a biogas according to [9], wherein
the tank has a first side surface and a second side surface,
the second side surface is a side surface opposite to the first side surface, and
the biogas discharged in the discharging is discharged from the first side surface and the second side surface.

[11] The method for discharging a biogas according to [9] or [10], wherein in the returning, at least a portion of the biogas discharged from the tank is compressed and returned to the tank.

### Advantageous Effects of Invention

According to the present disclosure, there can be provided a biogas storage apparatus and a biogas discharging method capable of efficiently discharging a biogas.

### BRIEF DESCRIPTION OF DRAWINGS

FIG. 1 is a schematic diagram showing an example of a configuration of a biogas storage apparatus according to the present embodiment.

FIG. 2 is a plan view showing an example of a tank that the biogas storage apparatus according to the present embodiment comprises.

FIG. 3 is a side view showing the example of the tank that the biogas storage apparatus according to the present embodiment comprises.

FIG. 4 is a schematic view of a vehicle on which the biogas storage apparatus according to the present embodiment is mounted.

### DESCRIPTION OF EMBODIMENTS

Hereinafter, an embodiment of the present disclosure will be described. It should be noted, however, that the following description does not limit the claimed scope.

### Biogas Storage Apparatus

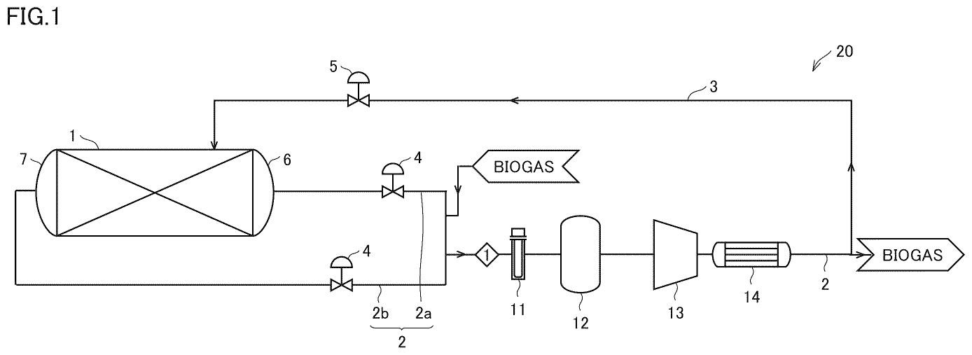

Referring to FIG. 1, a biogas storage apparatus 20 according to the present embodiment comprises a tank 1 for storing a biogas, a biogas inlet/outlet plumbing 2 connected to tank 1 for introducing the biogas into tank 1 and discharging the biogas from tank 1, and a biogas return plumbing 3 interconnecting tank 1 and biogas inlet/outlet plumbing 2 for returning to tank 1 at least a portion of the biogas discharged from tank 1. Tank 1 has an adsorbent introduced therein to adsorb the biogas. Hereinafter, biogas storage apparatus 20 according to the present embodiment will be described.

### Biogas

In the present embodiment, a “biogas” refers to a gas that is derived from at least one selected from the group consisting of livestock urine and feces and food residues and includes at least methane and carbonic acid gas (CO₂). The concentration of methane in the biogas is, for example, 50% by volume or more and 65% by volume or less, and the concentration of CO₂ in the biogas is, for example, 25% by volume or more and 40% by volume or less. The biogas may include other gases, such as nitrogen, oxygen, etc. The concentration of nitrogen in the biogas may for example be 5% by volume or more and 15% by volume or less, and the concentration of oxygen in the biogas may for example be 0.1% by volume or more and 5% by volume or less. Preferably, the biogas has hydrogen sulfide and moisture removed therefrom in advance.

### Tank

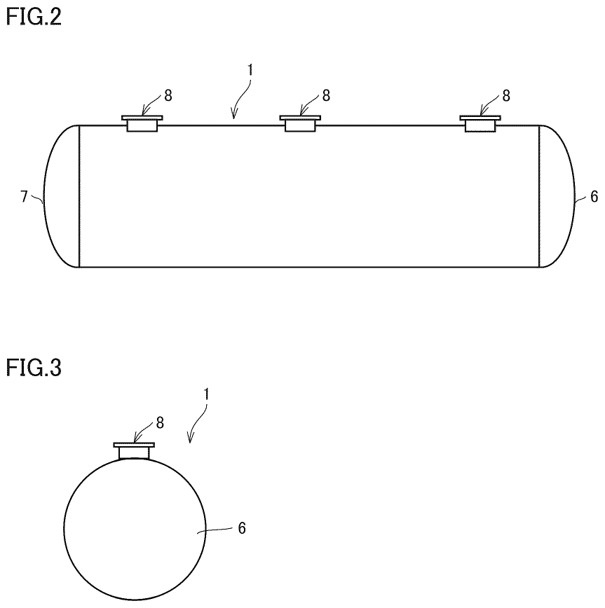

FIG. 2 is a plan view showing an example of tank 1, and FIG. 3 is a side view showing the example of tank 1. Tank 1 stores a biogas. Tank 1 has a pressure-resistant structure. Tank 1 has a first side surface 6 and a second side surface 7. In this case, second side surface 7 is a side surface opposite to first side surface 6.

Tank 1 preferably has a longitudinal direction and a lateral direction. In this case, first side surface 6 and second side surface 7 are side surfaces transverse to the longitudinal direction. That is, first side surface 6 and second side surface 7 are side surfaces parallel to the lateral direction, Referring to FIGS. 2 and 3, the longitudinal direction is a rightward/leftward direction in FIG. 2, and the lateral direction is a rightward/leftward direction in FIG. 3. In addition, as shown in FIG. 2, it is more preferable to install and use the tank such that the longitudinal direction is a horizontal direction.

Tank 1 has an adsorbent introduced therein. As the adsorbent is used an adsorbent capable of adsorbing methane and CO₂. An Example of such an adsorbent is activated carbon for example. The activated carbon is made for example of palm shell, coal, charcoal, phenolic resin, etc. The activated carbon may for example be powdered activated carbon, crushed carbon, granulated carbon, or the like. The activated carbon may have a particle size for example of 0.3 mm or more and 0.8 mm or less. In the present embodiment, crushed coal is suitably used

Tank 1 may have an adsorbent introduction unit 8. Adsorbent introduction unit 8 is preferably installed at an upper portion of tank 1. Adsorbent introduction unit 8 installed at the upper portion of tank 1 allows an adsorbent to be efficiently introduced into tank 1. Further, providing a plurality of adsorbent introduction units 8 allows the adsorbent to be introduced more efficiently. Note that FIG. 2 shows three adsorbent introduction units 8 provided by way of example, and adsorbent introduction unit 8 is not limited in number to any number.

### Biogas Inlet/Outlet Plumbing

Biogas inlet/outlet plumbing 2 is a plumbing connected to tank 1. A biogas is introduced into tank 1 or discharged from tank 1 via biogas inlet/outlet plumbing 2. That is, biogas inlet/outlet plumbing 2 functions as a biogas inlet plumbing when the biogas is introduced into tank 1, and biogas inlet/outlet plumbing 2 functions as a biogas outlet plumbing when the biogas is discharged from tank 1.

While biogas storage apparatus 20 in the present embodiment may comprise at least one biogas inlet/outlet plumbing 2, it preferably comprises two biogas inlet/outlet plumbings 2 (a first biogas inlet/outlet plumbing 2a and a second biogas inlet/outlet plumbing 2b). In this case, first biogas inlet/outlet plumbing 2a is connected to first side surface 6 of tank 1, and second biogas inlet/outlet plumbing 2b is connected to second side surface 7 of tank 1.

When the biogas is introduced into tank 1, the biogas is adsorbed, which generates heat of adsorption, which in turn elevates temperature of tank 1. Introducing the biogas from one biogas inlet/outlet plumbing 2 and releasing the heat of adsorption from the other biogas inlet/outlet plumbing 2 can suppress elevation in temperature of tank 1.

When the biogas is discharged from tank 1 through one biogas inlet/outlet plumbing 2, the discharged biogas may have an uneven composition, Discharging the biogas from both of biogas inlet/outlet plumbings 2 can discharge the biogas with a uniform composition.

Biogas storage apparatus 20 according to the present embodiment may comprise a first valve 4. The biogas is introduced into tank 1 and discharged from tank 1, as regulated by first valve 4.

### Biogas Return Plumbing

Biogas return plumbing 3 is a plumbing that interconnects tank 1 and biogas inlet/outlet plumbing 2. The biogas discharged from tank 1 at least partially returns to tank 1 via biogas return plumbing 3. This allows the biogas to be discharged with a uniform composition.

Biogas return plumbing 3 is preferably connected to a surface other than first and second side surfaces 6 and 7 located on a side close to biogas inlet/outlet plumbing 2. This allows the biogas to be discharged with a more uniform composition.

Referring to FIG. 1, biogas return plumbing 3 may for example be connected to an upper portion of tank 1 located on a side close to first biogas inlet/outlet plumbing 2a. In this case, first biogas inlet/outlet plumbing 2a functions as a biogas inlet plumbing when the biogas is introduced into tank 1.

Biogas storage apparatus 20 according to the present embodiment may comprise a second valve 5. The biogas is returned to tank 1 through biogas return plumbing 3, as regulated by second valve 5.

### Compression Means

Biogas storage apparatus 20 according to the present embodiment may comprise a compressor 13. Compressor 13 compresses at least a portion of the biogas discharged from tank 1. The biogas discharged from tank 1 is low in pressure. Furthermore, when the biogas is discharged from tank 1, heat of desorption due to desorption of the biogas decrease the temperature of tank 1. It is believed that discharging the biogas is suppressed as the temperature of tank 1 decreases. Compressor 13 compressing at least a portion of the biogas discharged from tank 1 and biogas return plumbing 3 returning the compressed biogas to tank 1 can suppress a decrease in temperature of tank 1 and facilitate discharging the biogas

### Others

Biogas storage apparatus 20 according to the present embodiment may comprise a heating means 11, a buffer tank 12, and a cooling means 14. These function when discharging a biogas.

Heating means 11 heats the discharged biogas. Heating means II may be used when the discharged biogas is low in temperature. Buffer tank 12 temporarily reserves the discharged biogas. Cooling means 14 cools the compressed biogas. Cooling means 14 may be used when the compressed biogas is high in temperature.

In view of handling, first valve 4 and second valve 5 are preferably provided on a side closer to first side surface 6.

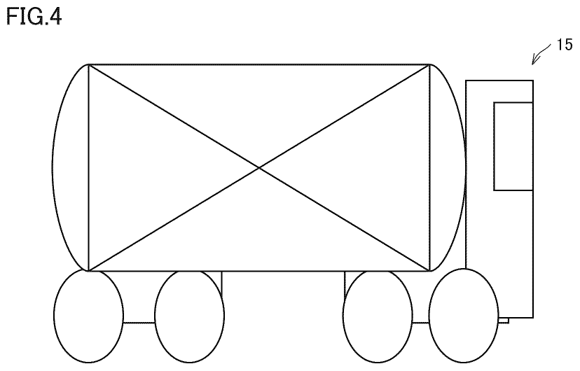

Biogas storage apparatus 20 according to the present embodiment is suitably used for example for collecting a biogas derived from urine and feces of livestock bred in a farm. From this point of view, biogas storage apparatus 20 is preferably of a portable type. The portable type is exemplified by a vehicle 15 (a lorry) with biogas storage apparatus 20 mounted thereon, as shown in FIG. 4.

### Biogas Discharging Method

A biogas discharging method according to the present embodiment comprises a discharging step of discharging a biogas from a tank, and a returning step of compressing at least a portion of the biogas discharged in the discharging step and returning the compressed portion to the tank. The returning step is performed while the discharging step is performed. Hereinafter, the biogas discharging method according to the present embodiment will be described with reference to FIGS. 1 to 3.

### Discharging Step

The discharging step is a step of discharging a biogas from tank 1.

Biogas storage apparatus 20 according to the present embodiment discharges the biogas from tank 1 via biogas inlet/outlet plumbing 2. Tank 1 and biogas inlet/outlet plumbing 2 have specifically been described above.

The biogas is discharged from tank 1 preferably at first side surface 6 and second side surface 7. Second side surface 7 is a side surface opposite to first side surface 6. This allows the biogas to be discharged with a uniform composition.

### Returning Step

The returning step is a step of returning to tank 1 at least a portion of the biogas discharged in the discharging step.

Biogas storage apparatus 20 according to the present embodiment returns a biogas to tank 1 via biogas return plumbing 3. Biogas return plumbing 3 has specifically been described above.

The returning step is performed while the discharging step is performed. Performing the returning step while performing the discharging step allows the biogas to be discharged with a uniform composition.

In the returning step, it is preferable that the biogas discharged from tank 1 have at least a portion compressed and returned to tank 1. The biogas discharged from tank 1 is low in pressure. Furthermore, when the biogas is discharged from tank 1, heat of desorption due to desorption of the biogas decreases the temperature of tank 1. It is believed that discharging the biogas is suppressed as the temperature of tank 1 decreases. Compressor 13 compressing at least a portion of the biogas discharged from tank 1 and biogas return plumbing 3 returning the compressed portion of the biogas to tank 1 can suppress a decrease in temperature of tank 1 and facilitate discharging the biogas.

### EXAMPLES

Hereinafter, examples will be described. It should be noted, however, that the following examples do not limit the claimed scope.

### Example 1

An apparatus having the configuration shown in FIG. 1 was prepared. A biogas derived from livestock urine and feces was prepared. The biogas contained about 54% by volume of methane, about 40% by volume of CO₂, about 5% by volume. of nitrogen, and about 1% by volume of oxygen. The biogas had its components analyzed through gas chromatography. As an adsorbent, activated carbon was introduced into tank 1. The biogas was introduced into tank 1 through biogas inlet/outlet plumbing 2a. After the biogas was introduced, tank 1 had a temperature of 40° C.

Subsequently, the biogas was discharged from tank 1 through biogas inlet/outlet plumbing 2a and biogas inlet/outlet plumbing 2b. The biogas was discharged in an amount of 100Nm 3 /h. The discharged biogas was heated by heating means 11 and reserved in buffer tank 12. The discharged biogas was controlled in temperature by heating means 11 to 20° C. The reserved biogas was compressed to 0.85 MPaG by compressor 13. The compressed biogas was cooled to 40° C. by cooling means 14. Thereafter, the biogas had a portion returned to tank 1 through biogas return plumbing 3. The biogas was returned in an amount of 60 Nm 3 /h. The biogas was discharged for 12 hours.

### Comparative Example 1

The biogas was discharged in the same method under the same conditions as in Example 1 except that the discharged biogas did not have a portion returned to tank 1 through biogas return plumbing 3.

### Evaluation

Example 1 and Comparative Example 1 were measured for the biogas's composition at a point 1 in FIG. 1 immediately after discharging the biogas was started and when discharging the biogas ended, as well as for temperature of tank 1 when discharging the biogas ended.

### Results

In Example 1, the biogas at point 1 in FIG. 1 immediately after discharging the biogas was started contained about 51% by volume of methane, about 33% by volume of CO₂, about 14% by volume of nitrogen, and about 2% by volume of oxygen. The biogas at point 1 in FIG. 1 when discharging the biogas ended contained about 49% by volume of methane, about 40% by volume of CO₂, about 10% by volume of nitrogen, and about 1% by volume of oxygen. When discharging the biogas ended, tank 1 had a temperature of 18° C.

In Comparative Example 1, in contrast, the biogas at point 1 in FIG. 1 immediately after discharging the biogas was started contained about 60% by volume of methane, about 26% by volume of CO₂, about 13% by volume of nitrogen, and about 1% by volume of oxygen. The biogas at point 1 in FIG. 1 when discharging the biogas ended contained about 55% by volume of methane, about 39.5% by volume of CO₂, about 5% by volume of nitrogen, and about 0.5% by volume of oxygen. When discharging the biogas ended, tank 1 had a temperature of 5° C.

In Example 1, the biogas immediately after discharging the biogas was started and that when discharging the biogas ended had a composition with a small variation, and tank 1 before discharging the biogas started and that when discharging the biogas ended had a small variation in temperature. On the other hand, in Comparative Example 1, the biogas immediately after discharging the biogas was started and that when discharging the biogas ended had a composition with a larger variation than in Example 1, and tank 1 before discharging the biogas started and that when discharging the biogas ended had a larger variation in temperature than in Example 1. Itis believed that compressing at least a portion of the biogas discharged from tank 1 and returning the compressed portion to tank 1 stabilize the composition of the discharged biogas and the temperature of tank 1.

The presently disclosed biogas storage apparatus and biogas discharging method can thus efficiently discharge a biogas. Furthermore, according to the present disclosure, conventionally discarded livestock urine and feces are effectively used and can thus contribute to some activity for sustainable development goals (SDGs).

It should be understood that the embodiments and examples disclosed herein are illustrative and non-restrictive in any respect. The scope of the present invention is defined by the terms of the claims rather than by the foregoing description, and encompasses any modification falling within the meaning and range equivalent to the terms of the claims.

### REFERENCE SIGNS LIST

1 tank, 2, 2a, 2b biogas inlet/outlet plumbing, 3 biogas return plumbing, 4 first valve, 5 second valve, 6 first side surface, 7 second side surface, 8 adsorbent introduction unit, 11 heating means, 12 buffer tank, 13 compressor, 14 cooling means, 15 vehicle, 20 biogas storage apparatus.

1. A biogas storage apparatus comprising:
a tank including an adsorbent to adsorb a biogas for storing the biogas;
a biogas inlet/outlet plumbing connected to the tank for introducing the biogas into the tank and discharging the biogas from the tank; and
a biogas return plumbing that interconnects the tank and the biogas inlet/outlet plumbing for returning to the tank at least a portion of the biogas discharged from the tank.

2. The biogas storage apparatus according to claim 1, wherein
the biogas inlet/outlet plumbing includes a first biogas inlet/outlet plumbing and a second biogas inlet/outlet plumbing,
the first biogas inlet/outlet plumbing is connected to a first side surface of the tank,
the second biogas inlet/outlet plumbing is connected to a second side surface of the tank, and
the second side surface is a side surface opposite to the first side surface.

3. The biogas storage apparatus according to claim 2, wherein
the tank has a longitudinal direction and a lateral direction, and
the first side surface and the second side surface are side surfaces transverse to the longitudinal direction.

4. The biogas storage apparatus according to claim 3, installed and used such that the longitudinal direction is a horizontal direction.

5. The biogas storage apparatus according to claim 1, further comprising a compressor that compresses at least a portion of the biogas discharged from the tank.

6. The biogas storage apparatus according to claim 2, comprising:
a first valve that opens and closes the biogas inlet/outlet plumbing; and
a second valve that opens and closes the biogas return plumbing, wherein
the first valve and the second valve are provided on a side closer to the first side surface.

7. The biogas storage apparatus according to claim 1, being portable.

8. The biogas storage apparatus according to claim 1, wherein
the biogas is a gas derived from at least one selected from the group consisting of livestock urine and feces and food residues, and
the biogas includes at least methane and carbonic acid gas.

9. A method for discharging a biogas from a biogas storage apparatus according to claim 1, comprising:
discharging the biogas from the tank; and
returning to the tank at least a portion of the biogas discharged in the discharging,
the returning being performed while the discharging is performed.

10. The method for discharging a biogas according to claim 9, wherein
the tank has a first side surface and a second side surface,
the second side surface is a side surface opposite to the first side surface, and
the biogas discharged in the discharging is discharged from the first side surface and the second side surface.

11. The method for discharging a biogas according to claim 9, wherein in the returning, at least a portion of the biogas discharged from the tank is compressed and returned to the tank.
